(19) United States
(12) Patent Application Publication
(10) Pub. No.: US 2008/0247316 A1
(43) Pub. Date: Oct. 9, 2008

(54) Method Circuit and System for Data Flow Control

(76) Inventors: Michael Bar-Joshua, Haifa (IL); Bruce Leroy Beukema, Hayfield, MN (US); Alexander Mesh, Haifa (IL); Shaul Yifrach, Haifa (IL)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/695,681

(22) Filed: Apr. 3, 2007

(51) Int. Cl. H04N 5/91

(52) U.S. Cl. 370/236

(57) ABSTRACT

Disclosed is a method and circuit for a receiver to receive data from an associated data transmitter. The receiver may include a signaling module adapted to transmit a Ready-To-Receive (“RTR”) signal to the associated transmitter when a number of vacant bits in a data buffer exceeds a delay associated value.

### FIELD OF THE INVENTION

The present invention relates generally to computing and communication devices and systems. More particularly, the present invention relates to a novel method, circuit and system for data flow control between a transmitter and a receiver.

### BACKGROUND OF THE INVENTION

Many methods for data flow control are known in the prior art. Since the invention of digital communication, the synchronization of data flow between a transmitting device or circuit to a receiving device or circuit has been an issue addressed by countless numbers of communication engineers. As data carrying capacity on communication channels/links (wired and wireless) has increased, so has the complexity of synchronizing data flow between devices.

Whether it is a data communication between two devices (e.g., point-to-point) or more (e.g., point-to-multipoint), a communication protocol is usually required. Communication protocols are typically defined as a set of rules and/or communication parameters to which two or more devices intended to communicate with one another adhere to. In systems which require a data flow mechanism, one of two major solutions is usually used. Credits based mechanism—suitable for network-oriented systems. Ready-to-Receive (“RTR”) mechanism—suitable for direct connection systems. RTR is one of the simpler protocols for point-to-point communication between two devices. According to this protocol, a receiving device or circuit transmits an RTR signal to a corresponding transmitting device or circuit when the receiving device/circuit is ready to receive data from the transmitting device/circuit. Typically, an RTR is produced by a receiving device/circuit (“Rx”) when it is determined that the device/circuit has sufficient data buffer space to store the maximum data burst the transmitting device/circuit (“Tx”) will transmit in a single burst.

The advantage of the RTR mechanism over the credits-based mechanism is by its simplicity. The Rx side does all the calculation and the Tx side only responds to the RTR indication and needs no extra logic. In an RTR mechanism implementation, a single signal is provided from one unit (Rx side) to the other unit (Tx side), thereby indicating that the receive unit has enough buffers to accept data.

In non-ideal systems, where a delay exists between the Rx and the Tx sides, the delay causes the Rx side to reserve spare buffers (with correlation to the delay factor) in order to avoid buffer overflow.

These spare buffers remain most of the time unused, especially in cases where the characteristic of the data is of a stream of small chunks. Additionally, in a given Rx unit where the amount of the receive buffers is limited (by size), latency may be affected. The receiving side may not assert the RTR indication until it can be sure that it has enough buffers for the incoming data, thus it must de-assert the RTR signal even if the receiver buffer is not completely full.

Accordingly, there is a need in the field of digital communication for improved methods, circuits and systems for data flow control.

### SUMMARY OF THE INVENTION

According to some embodiments of the present invention, there is provided a receiver unit for receiving data from an associated data transmitter. The receiver comprises a signaling module adapted to transmit a Ready-To-Receive (“RTR”) signal to the associated transmitter when a number of vacant bits in a data buffer exceeds a delay associated value.

According to other embodiments of the present invention, there is provided a method of receiving data. The method comprises transmitting a Ready-To-Receive (“RTR”) signal to an associated transmitter when a number of vacant bits in a data buffer exceeds a delay associated value.

In accordance with some other embodiments of the present invention, there is provided a system. The system comprising a data transmitter, and a receiver adapted to transmit a Ready-To-Receive (“RTR”) signal to the transmitter when a number of vacant bits in a data buffer exceeds a delay associated value.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an exemplary block-diagram of a data-transmission system, according to some embodiments of the present invention.

FIG. 2 shows an exemplary block-diagram of an Receiver unit, according to some embodiments of the present invention.

FIG. 3 is a flowchart including the steps of a method of RTR transmission, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein. One of ordinary skill in the art should understand that the described invention may be used for all kinds of wireless or wire-line system.

According to some embodiments of the present invention, there is provided a data transmission system that comprises: a receiver unit adapted to receive data and a transmission unit adapted to transmit associated data.

According to some further embodiments of the present invention, the receiver unit may comprise a storage module and a signaling module.

According to some embodiments of the present invention, the signaling module may be adapted to transmit a Ready-To-Receive (“RTR”) signal to the transmission unit.

According to some embodiments of the present invention, a data transmission system may be associated with a specific Delay (“D”) factor. According to yet further embodiments of the present invention, the D factor may be determined in accordance with some parameters of the data transmission system.

According to some embodiments of the present invention, the parameters which may determine the D factor are physical delay lines between the transmitter and the receiver, link layer protocol delays, and higher level protocols overhead.

According to some embodiments of the present invention, the signaling module may monitor the storage unit. According to yet further embodiments of the present invention, the signaling module may associate a Vacancy (“V”) parameter with the storage unit, which V parameter is a dynamic number that represent the amount of free space in the storage unit.

According to some embodiments of the present invention, the free space parameter may be represented in packet size, Bits, or any other known unit in the art for calculating data storage space.

According to some further embodiment of the present invention, we denote V* as V divided by the packet size used by the system, for example if the storage module has 1 Megabit free storage space and data is received in packets of 200 Kb then V* equals 5.

According to further embodiments of the present invention, it should be known to one of ordinary skills in the art that the Delay factor of a system may be translated to a specific amount of data storage space (denoted by D*) in accordance with the system parameters, similar to the above explanation regarding V*.

According to some embodiments of the present invention, the signaling unit may transmit the RTR signal in correlation with (1) D factor and (2) V parameter.

According to some further embodiments of the present invention, when the V parameter is greater then the D factor the signaling unit may transmit RTR signal. According to yet further embodiments of the present invention, the signaling module may monitor V parameter after each transmit-receive data cycle has been completed.

According to some embodiments of the present invention, when V parameter is lower than D factor, the signaling unit may block the transmission of RTR signal for a period of D cycles. According to yet further embodiments of the present invention, after the signaling unit had de-asserted RTR signal for D cycles, the signaling unit may assert (transmit) RTR signal for a period of V cycles.

According to some embodiments of the present invention, when a comparison is made between V parameter and D factor it is equal to comparing V* and D* described hereinabove.

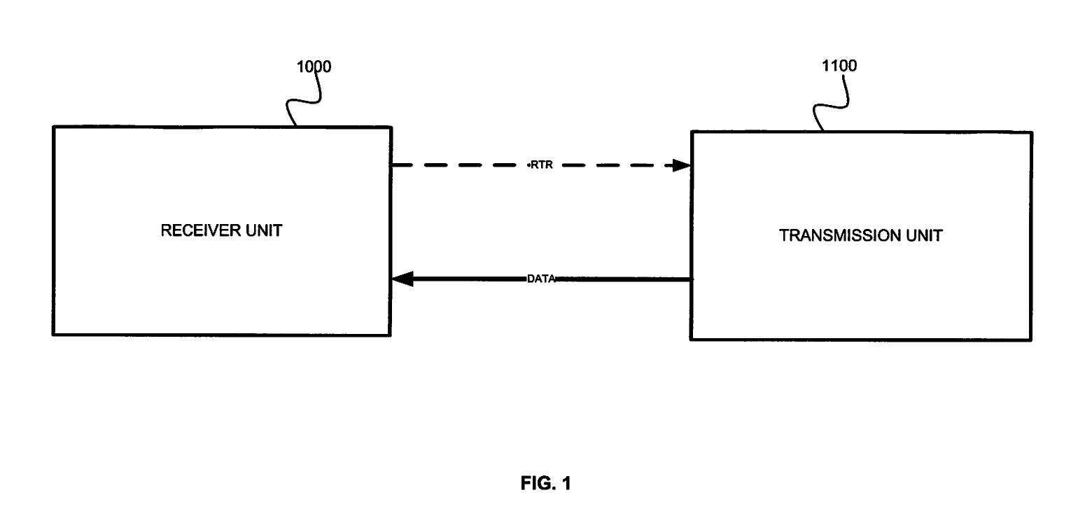

Turning now to FIG. 1, there is shown an exemplary embodiment of a data transmission system according to some embodiments of the present invention, the data transmission system comprises: a receiver unit adapted to receive data (1000) and a transmission unit (1100) adapted to transmit associated data.

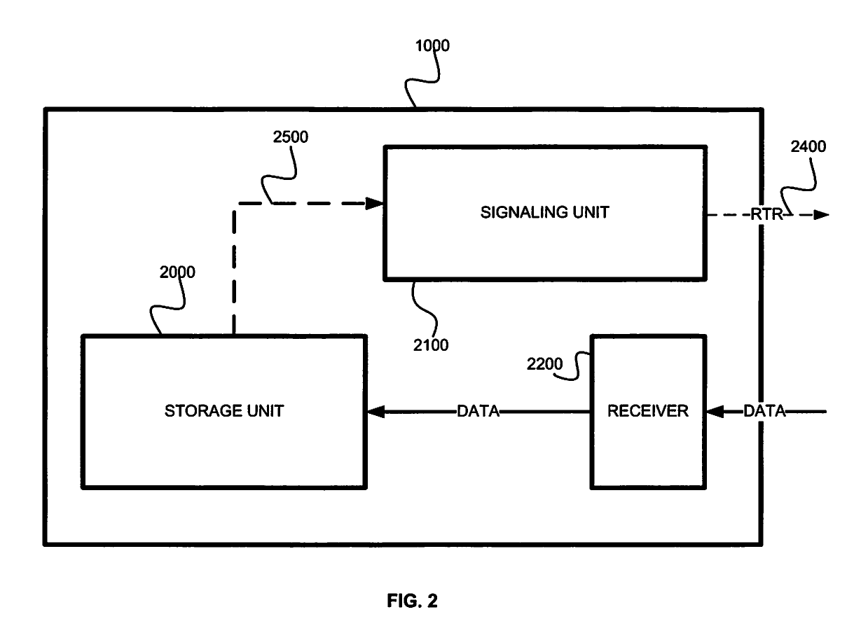

Turning now to FIG. 2, there is shown an exemplary embodiment of a receiver unit 1000 in accordance with some embodiments of the present invention. The receiver unit comprises: a storage module (2000), a signaling module (2100), and a receiver module (2200).

According to some embodiments of the present invention, the signaling module 2100 may be adapted to transmit a Ready-To-Receive (“RTR”) signal to the transmission unit (2400).

According to some embodiments of the present invention, a data transmission system may be associated with a specific Delay (“D”) factor. According to yet further embodiments of the present invention, the D factor may be determined in accordance with some parameters of the data transmission system.

According to some embodiments of the present invention, the signaling module may monitor the storage unit (2500). According to yet further embodiments of the present invention, the signaling module may associate a Vacancy (“V”) parameter with the storage unit, which V parameter may be a represent the amount of free space in the storage unit.

According to some embodiments of the present invention, the signaling unit may transmit the RTR signal in correlation with the (1) D factor and (2) the V parameter.

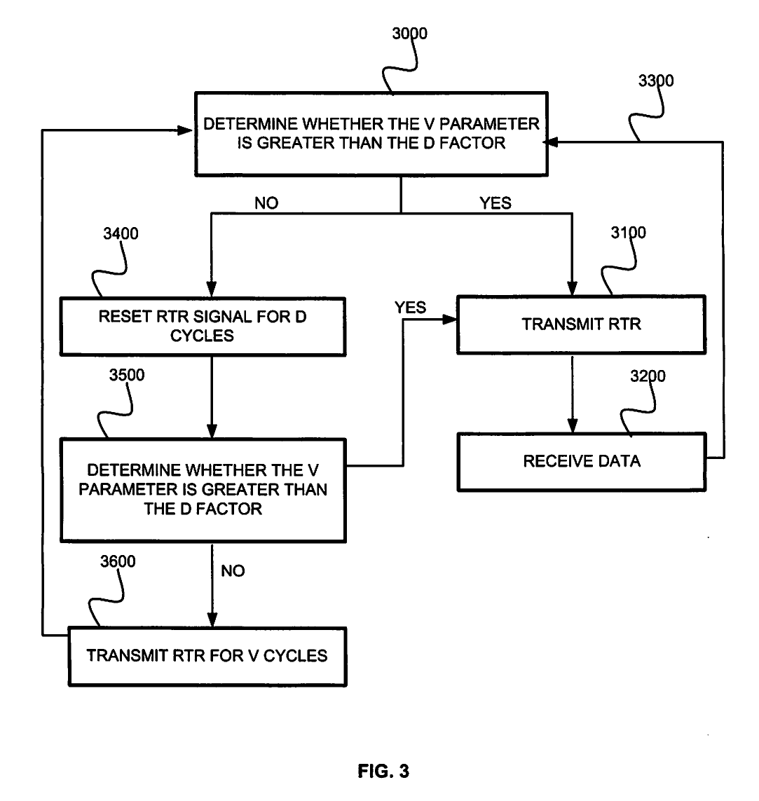

Turning now to FIG. 3, there is shown a flow chart depicting the steps of an exemplary method of RTR transmission in accordance with some embodiments of the present invention.

Referring now to step 3000, there the signaling module (2100) determines whether V parameter is greater than the D factor, it should be clear to one of ordinary skill in the art that this comparison is possible regardless of the Delay-factor units.

According to some embodiments of the present invention, if the V parameter is greater then the D factor, signaling unit may transmit the RTR signal (step 3100).

According to some embodiments of the present invention, transmission unit (1100) may transmit data that will be received by receiver module (2200) and stored in the storage module (step 3200).

According to yet further embodiments of the present invention, the signaling module may monitor the V parameter after each transmit-receive data cycle is completed (3300).

According to some embodiments of the present invention, when the V parameter is lower than the D factor, signaling unit may block the transmission of the RTR signal for a period of D cycles (step 3400). It should be clear to one of ordinary skill in the art that “D cycles” refers to the number of receive-transmit-cycles needed for the system to receive D* amount of data.

According to yet further embodiments of the present invention, after the signaling unit had de-asserted the RTR signal for D cycles, the signaling unit may monitor the V parameter and determine whether the V parameter is greater than the D factor (step 3500).

According to some embodiments of the present invention, if the V parameter is greater then the D factor, signaling unit may return to step 3100 described hereinabove.

According to some further embodiments of the present invention, if the D factor is greater then the V parameter, signaling unit may transmit RTR signal during a period of V* cycles (step 3600).

According to yet further embodiments of the present invention, after signaling unit had transmitted RTR signal during V* cycles it may return to step 3000 which was described above.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A receiver unit for receiving data from an associated data transmitter, said receiver comprising:
a signaling module adapted to transmit a Ready-To-Receive (“RTR”) signal to the associated transmitter when a number of vacant bits in a data buffer exceeds a delay associated value.

2. The receiver unit according to claim 1, further comprising:
a storage module.

3. The receiver unit according to claim 1, wherein the delay associated value is determined in accordance with a physical delay on lines between the transmitter and the receiver, link layer protocol delays and higher level protocols overhead.

4. The receiver unit according to claim 2, wherein said signaling module monitors the storage module.

5. The receiver unit according to claim 2, wherein said signaling module associates a vacancy parameter with said storage module.

6. The receiver unit according to claim 2, wherein transmitting a Ready-To-Receive (“RTR”) signal occurs when the vacancy parameter is greater than the delay associated value.

7. The receiver unit according to claim 2, wherein said signaling module is further adapted to block the transmission of a Ready-To-Receive signal.

8. A method of receiving data comprising:
transmitting a Ready-To-Receive (“RTR”) signal to an associated transmitter when a number of vacant bits in a data buffer exceeds a delay associated value.

9. The method according to claim 8, wherein said transmitting a Ready-To-Receive (“RTR”) signal is accomplished using a signaling module.

10. The method according to claim 8, wherein the number of vacant bits in a data buffer is stored within a storage module.

11. The method according to claim 8, wherein the delay associated value is determined based upon a physical delay on lines between the transmitter and the receiver, link layer protocol delays and higher level protocols overhead.

12. The method according to claim 10, wherein the signaling module monitors the storage module.

13. The method according to claim 9, wherein the signaling module associates a vacancy parameter with the storage module.

14. The method according to claim 9, wherein transmitting an Ready-To-Receive (“RTR”) signal occurs when the vacancy parameter is greater than the delay associated value.

15. The method according to claim 9, wherein the signaling module is further adapted to block the transmission of a Ready-To-Receive signal.

16. A system comprising:
a data transmitter; and
a receiver adapted to transmit a Ready-To-Receive (“RTR”) signal to said transmitter when a number of vacant bits in a data buffer exceeds a delay associated value.

17. The system according to claim 16, wherein said receiver comprises:
a signaling module; and
a storage module.

18. The system according to claim 16, wherein the delay associated value is determined based upon a physical delay on lines between the transmitter and the receiver, link layer protocol delays and higher level protocols overhead.

19. The system according to claim 17, wherein said signaling module monitors the storage module.

20. The system according to claim 17, wherein said signaling module associates a vacancy parameter with the storage module.
